(19) United States
(12) Patent Application Publication
(10) Pub. No.: US 2015/0334553 A1
(43) Pub. Date: Nov. 19, 2015

(54) RADIO LINK CONTROL STATUS PROTOCOL DATA UNIT HANDLING

(71) Applicant: QUALCOMM Incorporated, San Diego, CA (US)

(72) Inventors: Ming YANG, San Diego, CA (US); Tom CHIN, San Diego, CA (US); Qingxin CHEN, Del Mar, CA (US)

(73) Assignee: QUALCOMM Incorporated, San Diego, CA (US)

(21) Appl. No.: 14/276,682

(22) Filed: May 13, 2014

(51) Int. Cl. H04W 8/18; H04W 48/18

(52) U.S. Cl. CPC H04W 8/183; H04W 48/18; H04W 88/06

(57) ABSTRACT

A method of wireless communication with a multi subscriber identity module (SIM) multi standby UE includes tuning away from a data call on a first SIM to perform an activity for a second SIM. The method also includes tuning back to the data call on the first SIM and delaying, for a predetermined time period, a layer 2 message after tuning back. The layer 2 message can be a protocol data unit (PDU) status transmission in response to receiving a polling bit, a radio link control (RLC) protocol data unit (PDU) polling bit transmission, or
a data re-transmission.

### BACKGROUND

1. Field

Aspects of the present disclosure relate generally to wireless communication systems, and more particularly, to improving the handling of a radio link control (RLC) status protocol data unit (PDU) for a multi-subscriber identity module (SIM) multi-standby device.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes tuning away from a data call on a first subscriber identity module (SIM) to perform an activity for a second SIM. The method also includes tuning back to the data call on the first SIM. The method further includes delaying, for a predetermined time period, a layer 2 message after tuning back.

Another aspect of the present disclosure is directed to an apparatus including means for tuning away from a data call on a first SIM to perform an activity for a second SIM. The apparatus also includes means for tuning back to the data call on the first SIM. The apparatus further includes delaying, for a predetermined time period, a layer 2 message after tuning back.

In another aspect of the present disclosure, a computer program product for wireless communications in a wireless network having a non-transitory computer-readable medium is disclosed. The computer readable medium has non-transitory program code recorded thereon which, when executed by the processor(s), causes the processor(s) to perform operations of tuning away from a data call on a first SIM to perform an activity for a second SIM. The program code also causes the processor(s) to tune back to the data call on the first SIM. The program code further causes the processor(s) to delay, for a predetermined time period, a layer 2 message after tuning back.

Another aspect of the present disclosure is directed to an apparatus for wireless communication having a memory and at least one processor coupled to the memory. The processor(s) is configured to tune away from a data call on a first SIM to perform an activity for a second SIM. The processor(s) is also configured to tune back to the data call on the first SIM. The processor(s) is further configured to delay, for a predetermined time period, a layer 2 message after tuning back.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a timing diagram of a conventional system.

FIGS. 6A-6C are timing diagrams for RLC PDU handling according to aspects of the present disclosure.

FIG. 7 is a block diagram illustrating a method for improved RLC PDU handling according to one aspect of the present disclosure.

FIG. 8 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

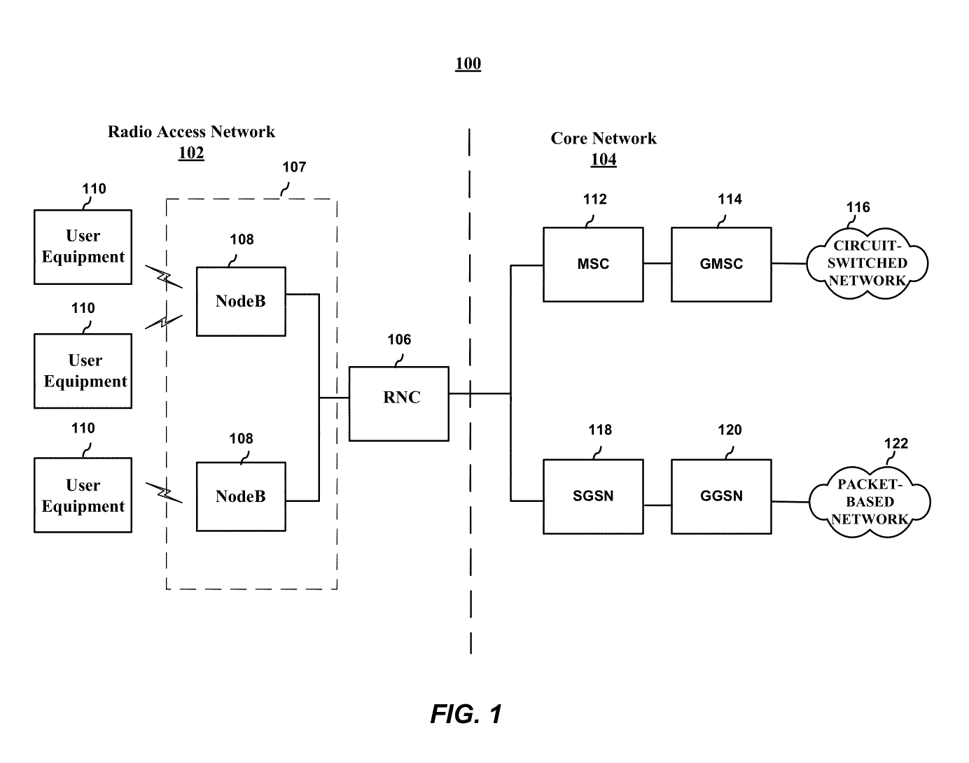

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

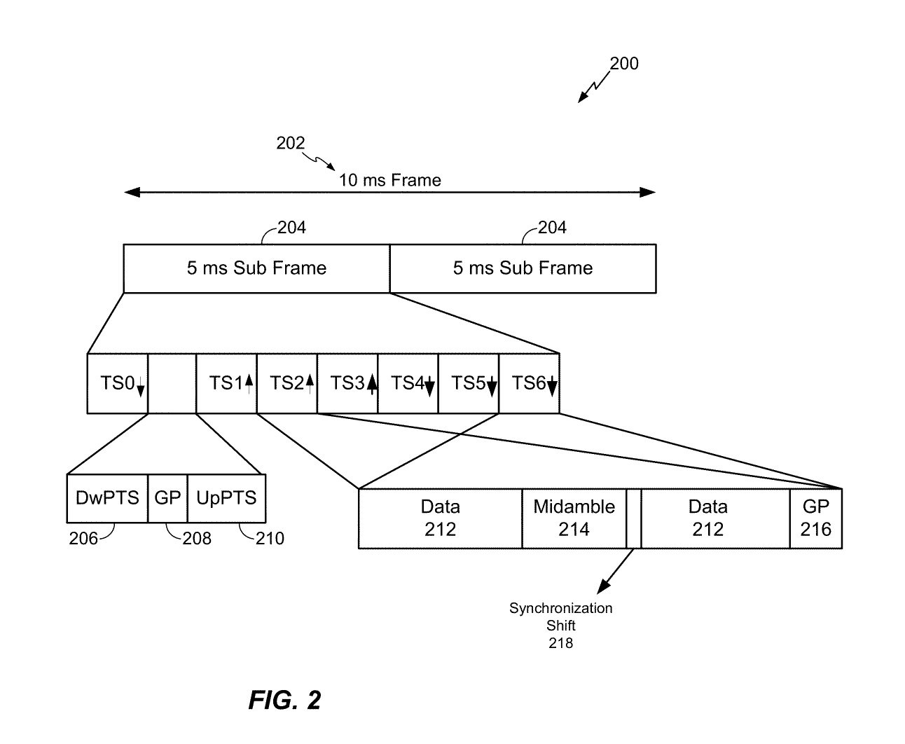

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

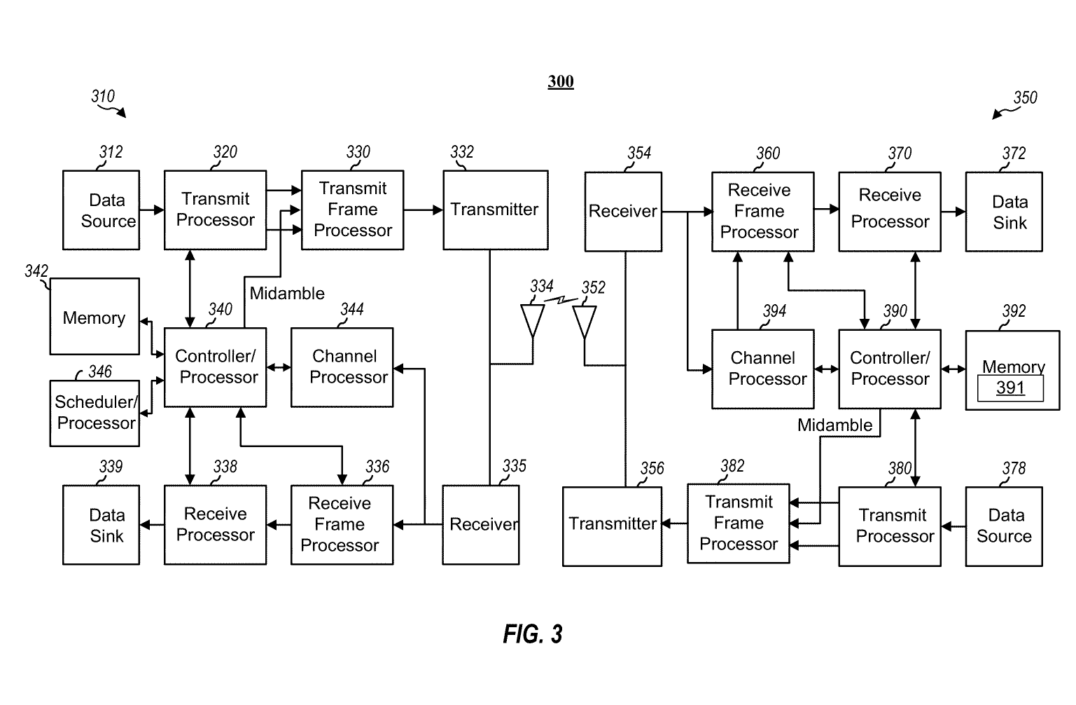

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support re-transmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support re-transmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a delay module 391 which, when executed by the controller/processor 390, configures the UE 350 for delaying transmission of a status PDU, a RLC PDU polling bit, and/or missing data. A scheduler/processor 346 at the node B 310 may allocate resources to the UEs and schedule downlink and/or uplink transmissions for the UEs.

High speed uplink packet access (HSUPA) or time division high speed uplink packet access (TD-HSUPA) is a set of enhancements to time division synchronous code division multiple access (TD-SCDMA) in order to improve uplink throughput. In TD-HSUPA, the following physical channels are relevant.

The enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the re-transmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels.

The hybrid automatic repeat request (hybrid ARQ or HARQ) indication channel for E-DCH (E-HICH) carries HARQ ACK/NAK signals.

The operation of TD-HSUPA may also have the following steps. First, in the resource request step, the UE sends requests (e.g., via scheduling information (SI)) via the E-PUCH or the E-RUCCH to a base station (e.g., NodeB). The requests are for permission to transmit on the uplink channels. Next, in a resource allocation step, the base station, which controls the uplink radio resources, allocates resources. Resources are allocated in terms of scheduling grants (SGs) to individual UEs based on their requests. In the third step (i.e., the UE Transmission step), the UE transmits on the uplink channels after receiving grants from the base station. The UE determines the transmission rate and the corresponding transport format combination (TFC) based on the received grants. The UE may also request additional grants if it has more data to transmit. Finally, in the fourth step (i.e., the base station reception step), a hybrid automatic repeat request (hybrid ARQ or HARQ) process is employed for the rapid re-transmission of erroneously received data packets between the UE and the base station.

The transmission of SI (scheduling information) may consist of two types in TD-HSUPA: (1) In-band and (2) Out-band. For in-band, which may be included in MAC-e PDU (medium access control e-type protocol data unit) on the E-PUCH, data can be sent standalone or may piggyback on a data packet. For Out-band, data may be sent on the E-RUCCH in case that the UE does not have a grant. Otherwise, the grant expires.

The scheduling information (SI) may include the following information or fields: the highest priority logical channel ID (HLID) field, the total E-DCH buffer status (TEBS) field, the highest priority logical channel buffer status (HLBS) field and the UE power headroom (UPH) field.

The highest priority logical channel ID (HLID) field unambiguously identifies the highest priority logical channel with available data. If multiple logical channels exist with the highest priority, the one corresponding to the highest buffer occupancy will be reported.

The total E-DCH buffer status (TEBS) field identifies the total amount of data available across all logical channels for which reporting has been requested by the radio resource control (RRC) and indicates the amount of data in number of bytes that is available for transmission and re-transmission in the radio link control (RLC) layer. When the medium access control (MAC) is connected to an acknowledged mode (AM) RLC entity, control protocol data units (PDUs) to be transmitted and RLC PDUs outside the RLC transmission window are also be included in the TEBS. RLC PDUs that have been transmitted but not negatively acknowledged by the peer entity shall not be included in the TEBS. The actual value of TEBS transmitted is one of 31 values that are mapped to a range of number of bytes (e.g., 5 mapping to TEBS, where 24<TEBS<32).

The highest priority logical channel buffer status (HLBS) field indicates the amount of data available from the logical channel identified by HLID, relative to the highest value of the buffer size reported by TEBS. In one configuration, this report is made when the reported TEBS index is not 31, and relative to 50,000 bytes when the reported TEBS index is 31. The values taken by HLBS are one of a set of 16 values that map to a range of percentage values (e.g., 2 maps to 6%<HLBS<8%).

The UE power headroom (UPH) field indicates the ratio of the maximum UE transmission power and the corresponding dedicated physical control channel (DPCCH) code power.

The serving neighbor path loss (SNPL) reports the path loss ratio between the serving cells and the neighboring cells. The base station scheduler incorporates the SNPL for inter-cell interference management tasks to avoid neighbor cell overload.

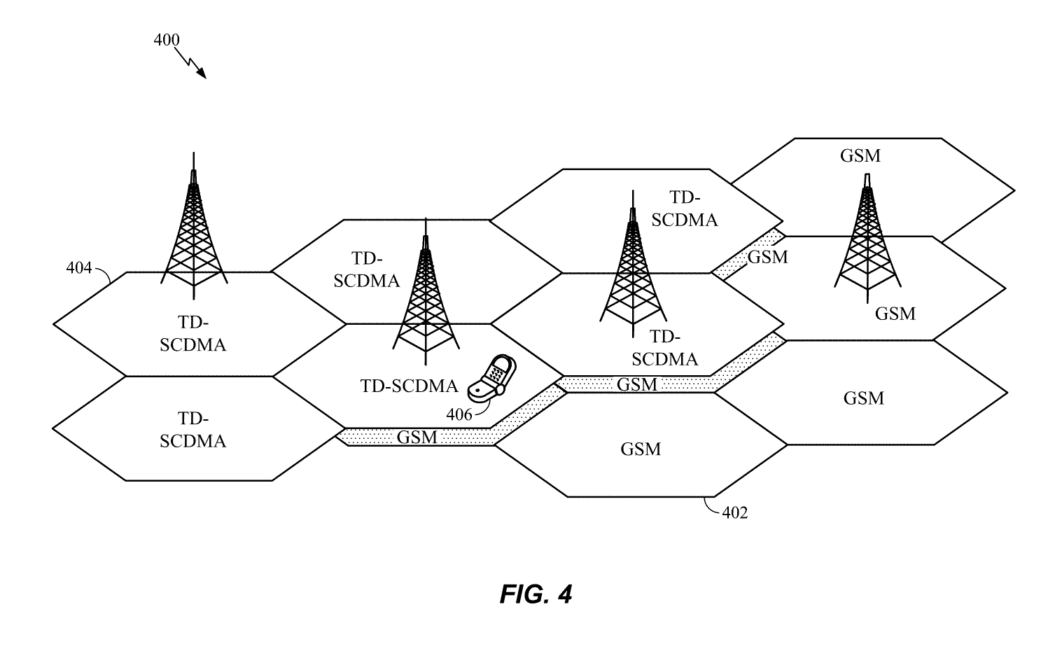

Some networks, such as a newly deployed network, may cover only a portion of a geographical area. Another network, such as an older more established network, may better cover the area, including remaining portions of the geographical area. FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

Handover from a first radio access technology (RAT) to a second RAT may occur for several reasons. First, the network may prefer to have the user equipment (UE) use the first RAT as a primary RAT but use the second RAT simply for voice service(s). Second, there may be coverage holes in the network of one RAT, such as the first RAT.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

The BSIC of a cell in the second RAT is “verified” when the UE decodes the synchronization channel (SCH) of the broadcast control channel (BCCH) carrier, identifies the BSIC, at least one time, with an initial BSIC identification and reconfirms. The initial BSIC identification is performed within a predefined time period (for example, Tidentify_abort=5 seconds). The BSIC is re-confirmed at least once every Tre-confirm_abort seconds (e.g., Tre-confirm_abort=5 seconds). Otherwise, the BSIC of a cell in the second RAT is considered “non-verified.”

The UE maintains timing information of some neighbor cells, e.g., at least eight identified GSM cells in one configuration. The timing information may be useful for IRAT handover to one of the neighbor cells (e.g., target neighbor cell) and may be obtained from the BSIC. For example, initial timing information of the neighbor cells may be obtained from an initial BSIC identification. The timing information may be updated every time the BSIC is decoded.

Improved RLC PDU Handling

In some cases, a UE may include more than one subscriber identity module (SIM)/universal subscriber identity module (USIM). A UE with more than one SIM may be referred to as a multi-SIM/multi-talk UE. In the present disclosure, a SIM may refer to a SIM or a USIM. Each SIM includes a unique International Mobile Subscriber Identity (IMSI) and service subscription information. Moreover, each SIM may be associated with a unique phone number. Thus, the UE may use each SIM to send and receive phone calls.

Furthermore, in some cases, the UE may have different baseband modules for different networks. For example, the UE may include a TD-SCDMA baseband module and a GSM baseband module. In one configuration, each baseband module is associated with a different SIM. For example, the TD-SCDMA baseband module may be associated with a first SIM and a GSM baseband module may be associated with a second SIM.

Additionally, in one configuration, the multi-baseband module UE is configured for multiple receive chains. In this configuration, the UE is referred to as a multi-SIM multi-standby UE. Still, in another configuration, the multiple baseband UE is configured for multiple transmit and multiple receive chains. In this configuration, the UE is referred to as a multi-SIM multi-active UE. In the present disclosure the term UE refers to a multi-SIM multi-active and/or multi-SIM multi-standby UE.

The multi-SIM multi-standby UE may have a single radio frequency (RF) chain, such as a single transmit/receive chain. When communications of a first RAT are in a current/original operation, such as dedicated channel (DCH) mode (i.e., without voice traffic) or connected mode with a first RAT, the multi-SIM multi-standby UE supports tuning away from the first RAT (e.g., TD-SCDMA) to a second RAT (e.g., GSM). Tuning away to the second RAT may be accomplished with reduced interruption to the original operation of the first RAT. When the UE is in the original operation of the first RAT, the UE periodically tunes away from the first RAT to the second RAT to monitor activities (e.g., a page) from the second RAT.

In some implementations, if the UE detects a page from the second RAT when the UE is tuned away from the first RAT, the multi-SIM multi-standby UE suspends all operations of the first RAT and transitions to the second RAT. Otherwise, the UE returns to the first RAT and attempts to recover the original operation of the first RAT. Moreover, if the UE does not detect a page from a second RAT, the UE tunes back to the first RAT and attempt to recover to the original operation to resume high speed data transmissions via the first RAT.

In some cases, during a tune away gap, high speed data may be lost or out of sequence because the network is unaware that the UE tuned away. As an example, the data may be lost or out of sequence because both the grant and the high speed data channel fall within the tune away gap. As another example, the UE receives a grant, however, the high speed data transmission falls within the gap. As yet another example, the grant falls within the gap and the UE receives the high speed data after tuning back.

When the UE tunes back, a hybrid automatic repeat request (HARQ) process may specify multiple sub-frames to recover the high speed data that may have been lost. Still, if a UE sends a status PDU unit when receiving a polling bit from the network and when the time status prohibit (TSP) timer is expiring, the network may be triggered to re-transmit PDUs that may have been recovered via the HARQ recovery process. That is, duplicated PDUs may be transmitted, thereby degrading throughput and reducing air interface capacity. Alternatively, if the UE performs PDU re-transmissions in response to receiving a status PDU from the network, duplicate PDUs may be transmitted, thereby degrading throughput and reducing air interface capacity.

According to an aspect of the present disclosure, when a UE tunes back to a first RAT on the first SIM during a predetermined time period, the UE delays transmission of a status PDU when receiving a polling bit from network. In another configuration, the UE does not perform a PDU re-transmission when receiving a status PDU from the network. In yet another configuration, the UE delays a transmission of an RLC PDU polling bit to the network. In each of these scenarios, the UE tunes back to a first RAT after tuning away from the first RAT to monitor or perform some type of operation on a second RAT.

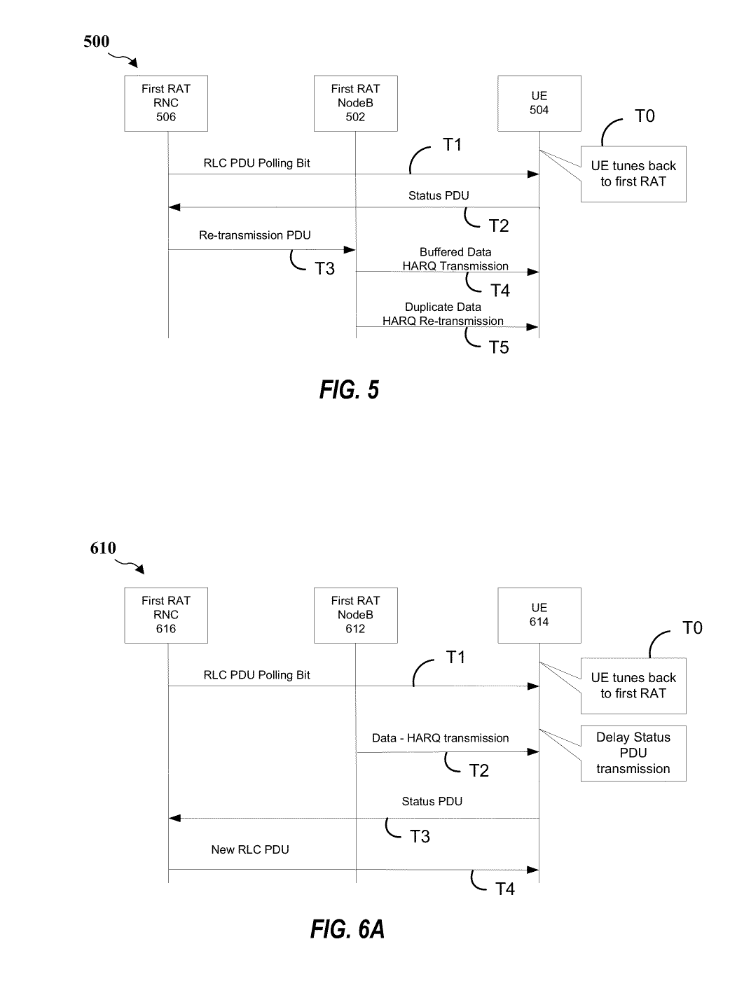

FIG. 5 illustrates a timing diagram 500 of conventional system. As shown in FIG. 5, at time T0 the UE tunes back to an NodeB 502 of a first RAT. After tuning back, the UE receives an RLC PDU polling bit from the network (time T1). The transmission of the RLC PDU polling bit may be triggered by a timer or another event, such as a number of PDUs transmitted, number of bytes transmitted, last PDU in the memory, and/or last re-transmission PDU in memory. In response to receiving the RLC PDU polling bit, the UE 504 transmits a status PDU (time T2). The status PDU may indicate a number of received PDUs and/or a number of missing PDUs (e.g., data packets). For example, in response to receiving an RLC PDU polling bit, the UE transmits a status PDU indicating that the UE received PDU number five and is missing PDU number two and PDU number three. As previously discussed, high speed data, such as PDUs, may be missing or out of sequence because the network is unaware that the UE tuned away. It should be noted that the PDU re-transmission, the status PDU, and the RLC PDU polling bit are layer 2 messages.

In response to the indication that the UE 504 is missing one or more PDUs, the RNC 506 may transmit a layer 2 PDU re-transmission request message to the NodeB 502 (T3). Moreover, at time T4, the first RAT NodeB 502 may transmit data via the physical layer based on the HARQ recovery process (i.e., HARQ transmission). In one configuration, the data is buffered while the UE tuned away from the first RAT. The buffered data may correspond to the missing PDU(s) indicated in the status PDU. Finally, at time T5, the first RAT NodeB 502 also performs a data re-transmission (i.e., HARQ re-transmission) via the physical layer in response to the layer 2 PDU re-transmission message received at time T3. The duplicate data (T5) may be the same as the buffered data transmitted at time T4. Thus, in a conventional system, the UE 504 may receive the same data at two different times. The redundant data transmission may decrease network throughput and/or reduce system performance. It should be noted that the RNC 506 and NodeB 502 are associated with the first RAT.

Therefore, it is desirable to mitigate data re-transmissions (i.e., redundant PDU transmissions) after a UE tuned back to a serving RAT. Specifically, as previously discussed, the physical layer includes a data recovery procedure via the HARQ process. Thus, missing data re-transmissions may be mitigated via the physical layer data recovery procedure. Therefore, in one configuration, the transmission of a status PDU or an RLC PDU polling bit is delayed for a predetermined time period so that the data may be recovered by the physical layer. In another configuration, re-transmission of missing data is delayed or terminated so that the missing data may be recovered via the HARQ recovery process.

According to an aspect of the present disclosure, the predetermined time period is determined based on a tune away gap length, a channel quality (for example channel quality indicator (CQI)) when the UE tuned back to the serving RAT, a number of re-transmission PDUs in a buffer, and/or a HARQ round trip time. The predetermined time period is specified so that, after tuning back to the serving RAT, a HARQ process may recover data that was not received while the UE tuned away from the serving RAT.

The predetermined time period may increase when a time for the tune away gap is longer and when then channel quality is lower. Alternatively, the predetermined time period may be reduced when a time for the tune away is shorter and the channel quality is improved. After the predetermined time period, the UE may transmit an updated status PDU. In another configuration, after the predetermined time period, the UE transmits a polling request to the network for an updated status PDU. In still yet another configuration, after the predetermined time period, the UE delays or terminates the re-transmission of missing data.

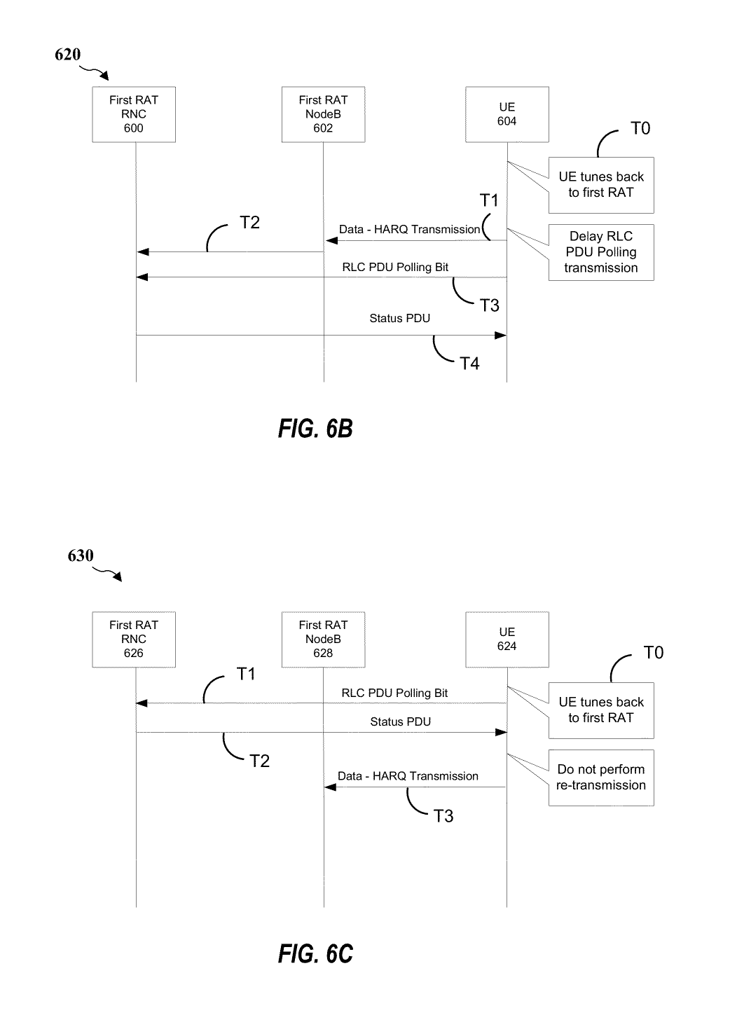

FIG. 6A illustrates a timing diagram 610 for delaying the transmission of a status PDU according to an aspect of the present disclosure. As shown in FIG. 6A, at time T0 the UE tunes back to a NodeB 612 of a first RAT on a first SIM. That is, the UE may have tuned away from the first RAT NodeB 612 associated with the first SIM to perform an activity for the second SIM of the UE. The UE may be tuned to the first RAT for a data call or other data activity. Furthermore, the activity performed by the second SIM may include monitoring for paging information of a second RAT, collecting a system information block (SIB) of a second RAT, and/or performing cell reselection for a second RAT. The second RAT is different from the serving RAT (i.e., first RAT) associated with the data call.

After tuning back, the UE receives an RLC PDU polling bit from the network (time T1). In a conventional system, the UE transmits a response to the RLC PDU polling bit. In contrast to the conventional system, in one configuration, the UE delays the response to the RLC PDU polling bit received at time T1. Aspects of the present disclosure describe a first RAT, which may also be referred to as a serving RAT.

As previously discussed, the delay may be based on a predetermined time period that corresponds to a length in time of the tune away gap, channel quality, a number of re-transmission PDUs in a buffer, and/or a HARQ round trip time. In one configuration, the delay increases when the length of time for the tune away gap increases and when then channel quality is reduced. Alternatively, the delay decreases when the length of time for the tune away gap decreases and when then channel quality is increased.

Furthermore, as shown in FIG. 6A, at time T2, the UE 614 recovers buffered data (e.g., with a HARQ process) that was not received when the UE tuned away from the first RAT 612. After the predetermined time period (i.e., delay), the UE 614 transmits the updated status PDU at time T3. In contrast to the conventional system, the status PDU does not indicate that the UE 614 is missing data. Rather, because, at time T2, the UE 614 recovered the buffered data (i.e., HARQ transmission) from the first RAT NodeB 612, the status PDU of time T3 indicates the data (i.e., PDU) was received. That is, the status PDU does not indicate that PDUs are missing or out of order. Thus, duplicate data is not re-transmitted. Finally, at time T4, the first RAT RNC 616 may initialize a new PDU transmission.

FIG. 6B illustrates a timing diagram 620 for delaying the transmission of an RLC PDU polling bit according to an aspect of the present disclosure. As shown in FIG. 6B, at time T0 the UE 604 tunes back to a NodeB 602 of a first RAT. In a conventional system, after tuning back, the UE transmits an RLC PDU polling bit. Still, in contrast to the conventional system, in one configuration, the UE 604 delays the transmission of the RLC PDU polling bit so that, at time T1, the UE 604 may transmit buffered data (i.e., HARQ transmission) to the first RAT NodeB 602. The transmitted data may be data that was not transmitted (i.e., received by the network) when the UE 604 tuned away from the first RAT NodeB 602.

Furthermore, at time T2, the first RAT NodeB 602 transmits the data and/or an indication that the data was received to the RNC 600. After the predetermined time period (i.e., delay), the UE 604 transmits the RLC PDU polling bit at time T3. In response to receiving the RLC PDU polling bit at time T3, the first RAT RNC 600 transmits the status PDU at time T4. In this configuration, because the UE 604 delayed transmission of the RLC PDU polling bit to allow for transmission of the buffered data (time T1), the status PDU indicates the data was successfully received. That is, the status PDU does not indicate missing PDUs or out of sequence PDUs.

FIG. 6C illustrates a timing diagram 630 for delaying the re-transmission of missing data according to an aspect of the present disclosure. As shown in FIG. 6C, at time T0 the UE 624 tunes back to a NodeB 628 of a first RAT. In one configuration, after tuning back, the UE 624 transmits an RLC PDU polling bit at time T1. In response to receiving the RLC PDU polling bit at time T1, the first RAT RNC 626 transmits the status PDU at time T2. The status PDU may indicate that PDUs are missing or out of sequence. As previously discussed, high speed data, such as PDUs, may be missing or out of sequence because the network is unaware that the UE tuned away.

In contrast to the conventional system, the UE of the present configuration delays the re-transmission of the missing data in response to receiving the status PDU (at time T2). That is, in this configuration, the delay is specified so that, at time T3, the UE may transmit the buffered data (i.e., HARQ transmission) according to the HARQ recovery process.

Aspects of the present disclosure refer to transmitting and re-transmitting data. The aspects of the present disclosure are contemplated for high speed data. Of course, other types of data are also contemplated for aspects of the present disclosure and the present disclosure is not limited to high speed data.

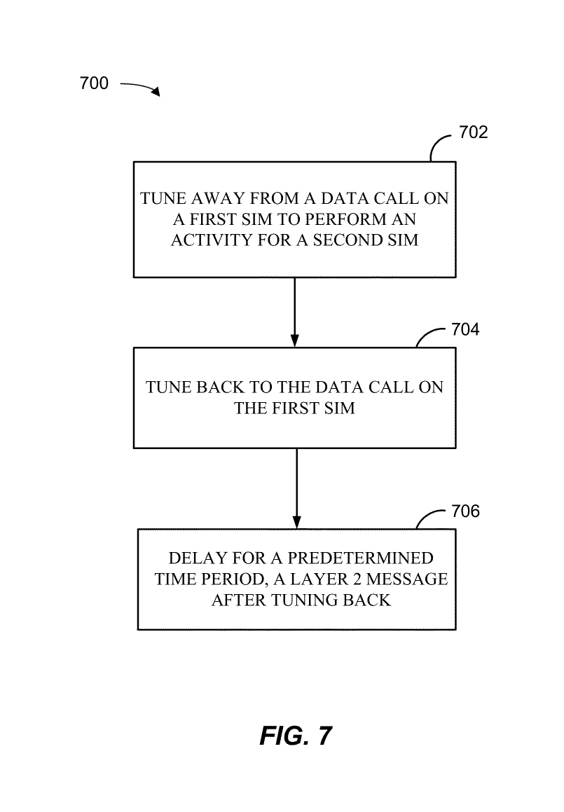

FIG. 7 shows a wireless communication method 700 according to one aspect of the disclosure. A UE tunes away from a data call on a first SIM to perform an activity for a second SIM, as shown in block 702. The UE tunes back to the data call on the first SIM, as shown in block 704. Furthermore, as shown in block 706, the UE delays, for a predetermined time period, a layer 2 message after tuning back.

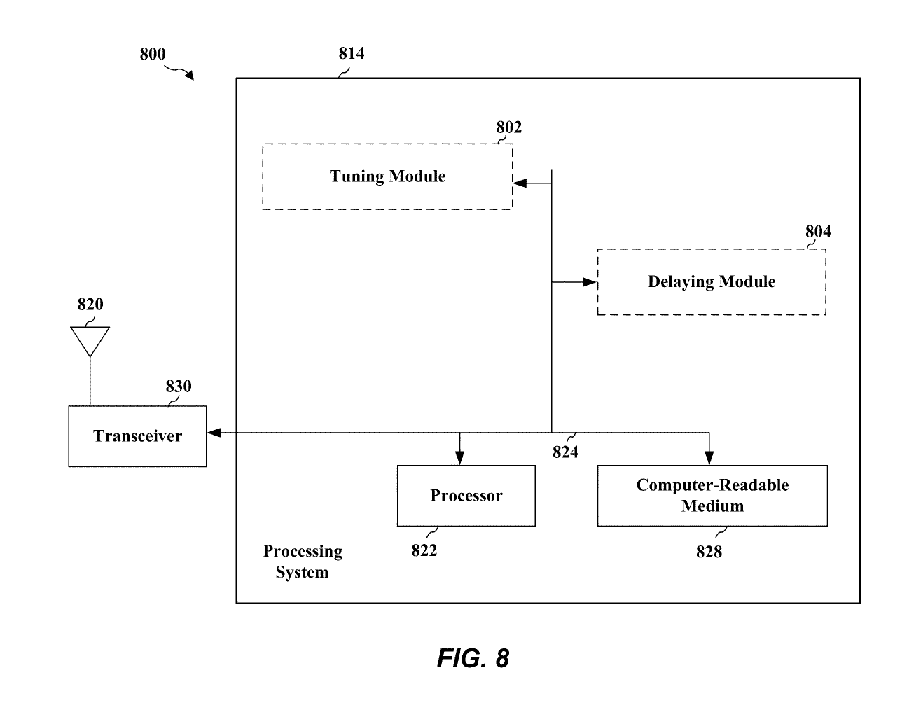

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804 and the non-transitory computer-readable medium 828. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a non-transitory computer-readable medium 828. The processor 822 is responsible for general processing, including the execution of software stored on the computer-readable medium 828. The software, when executed by the processor 822, causes the processing system 814 to perform the various functions described for any particular apparatus. The computer-readable medium 828 may also be used for storing data that is manipulated by the processor 822 when executing software.

The processing system 814 includes a tuning module 802 for tuning away from a data call on a first SIM to perform an activity for a second SIM. The tuning module 802 may also be configured to tune back to the data call on the first SIM. As shown in FIG. 8 one tuning module is specified for tuning away and tuning back. Of course, separate modules may also be configured for tuning away from the data call and tuning back to the data call. The processing system 814 also includes a delaying module 804 for delaying a layer 2 message for a predetermined time period, after tuning back. The modules may be software modules running in the processor 822, resident/stored in the computer readable medium 828, one or more hardware modules coupled to the processor 822, or some combination thereof. The processing system 814 may be a component of the UE 350 and may include the memory 392, and/or the controller/processor 390.

In one configuration, an apparatus such as a UE is configured for wireless communication including means for tuning. In one aspect, the tuning means may be the antennas 352, the receiver 354, the channel processor 394, the receive frame processor 360, the receive processor 370, the transmitter 356, the transmit frame processor 382, the transmit processor 380, the controller/processor 390, the memory 392, tuning module 802, and/or the processing system 814 configured to perform the tuning. The UE is also configured to include means for delaying. In one aspect, the delaying means may be the channel processor 394, the transmit frame processor 382, the transmit processor 380, the controller/processor 390, the memory 392, delay module 391, delaying module 804 and/or the processing system 814 configured to perform the delaying. In one configuration, the means functions correspond to the aforementioned structures. In another aspect, the aforementioned means may be any module or any apparatus configured to perform the functions recited by the aforementioned means.

Several aspects of a telecommunications system has been presented with reference to TD-SCDMA and TD-HSPA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication with a multi subscriber identity module (SIM) multi standby user equipment (UE), comprising:
tuning away from a data call on a first SIM to perform an activity for a second SIM;
tuning back to the data call on the first SIM; and
delaying, for a predetermined time period, a layer 2 message after tuning back.

2. The method of claim 1, in which the layer 2 message is a protocol data unit (PDU) status transmission in response to receiving a polling bit.

3. The method of claim 1, in which the layer 2 message is a radio link control (RLC) protocol data unit (PDU) polling bit transmission that is transmitted when a trigger condition is met.

4. The method of claim 3, in which the trigger condition is time, number of PDUs transmitted, number of bytes transmitted, last PDU in a memory unit, a last re-transmission PDU in memory, or a combination thereof.

5. The method of claim 1, in which the layer 2 message is a data re-transmission.

6. The method of claim 1, in which the predetermined time period is based at least in part on tune away gap length, channel quality associated with the first SIM, a number of re-transmission PDUs in a buffer, a HARQ round trip time, or a combination thereof.

7. The method of claim 1, in which the activity performed by the second SIM comprises at least monitoring for a page, collecting a system information block (SIB), performing cell reselection, or a combination thereof.

8. A multi subscriber identity module (SIM) multi standby user equipment (UE), comprising:
a memory unit; and
at least one processor coupled to the memory unit, the at least one processor being configured:
to tune away from a data call on a first SIM to perform an activity for a second SIM;
to tune back to the data call on the first SIM; and
to delay, for a predetermined time period, a layer 2 message after tuning back.

9. The UE of claim 8, in which the layer 2 message is a protocol data unit (PDU) status transmission in response to receiving a polling bit.

10. The UE of claim 8, in which the layer 2 message is a radio link control (RLC) protocol data unit (PDU) polling bit transmission that is transmitted when a trigger condition is met.

11. The UE of claim 10, in which the trigger condition is time, number of PDUs transmitted, number of bytes transmitted, last PDU in a memory unit, a last re-transmission PDU in memory, or a combination thereof.

12. The UE of claim 8, in which the layer 2 message is a data re-transmission.

13. The UE of claim 8, in which the predetermined time period is based at least in part on tune away gap length, channel quality associated with the first SIM, a number of re-transmission PDUs in a buffer, a HARQ round trip time, or a combination thereof.

14. The UE of claim 8, in which the activity performed by the second SIM comprises at least monitoring for a page, collecting a system information block (SIB), performing cell reselection, or a combination thereof.

15. A computer program product for wireless communications with a multi subscriber identity module (SIM) multi standby user equipment (UE), the computer program product comprising:
a non-transitory computer-readable medium having program code recorded thereon, the program code comprising:
program code to tune away from a data call on a first SIM to perform an activity for a second SIM;
program code to tune back to the data call on the first SIM; and
program code to delay, for a predetermined time period, a layer 2 message after tuning back.

16. The computer program product of claim 15, in which the layer 2 message is a protocol data unit (PDU) status transmission in response to receiving a polling bit.

17. The computer program product of claim 15, in which the layer 2 message is a radio link control (RLC) protocol data unit (PDU) polling bit transmission that is transmitted when a trigger condition is met.

18. The computer program product of claim 17, in which the trigger condition is time, number of PDUs transmitted, number of bytes transmitted, last PDU in a memory unit, a last re-transmission PDU in memory, or a combination thereof.

19. The computer program product of claim 15, in which the layer 2 message is a data re-transmission.

20. The computer program product of claim 15, in which the predetermined time period is based at least in part on tune away gap length, channel quality associated with the first SIM, a number of re-transmission PDUs in a buffer, a HARQ round trip time, or a combination thereof.
